(19) United States
(12) Patent Application Publication
(10) Pub. No.: US 2012/0179330 A1
(43) Pub. Date: Jul. 12, 2012

(54) FUNCTION ACTIVATION

(75) Inventors: Lars Eriksson Normand, Goteborg (SE); Jenny Magnusson, Hisings-Karra (SE)

(73) Assignee: VOLVO LASTAVAGNAR AB, Goteborg (SE)

(21) Appl. No.: 13/378,965

(22) PCT Filed: Jun. 17, 2009
(86) PCT No.: PCT/SE2009/000309

§ 371 Date: Jan. 13, 2012

(51) Int. Cl. G06F 7/00

(52) U.S. Cl. 701/36

(57) ABSTRACT

A method is provided for enabling at least one function to be stored in a vehicle communication system in a heavy vehicle or working machine. The system includes information about each function and information about a respective output signal relating to each function. The system further includes information about a respective function identity code unique for each function. In the method, a master Electronic Control Unit (ECU) in the system receives an actuator identity code which relates to an actuator connected to the system, the master ECU compares the received actuator identity code with the function identity codes, and the master ECU assigns a function with a function identity code that corresponds with the actuator identity code so that the actuator is enabled to control the output signal relating to the assigned function.

### BACKGROUND AND SUMMARY

The present invention relates to a method for enabling at least one function being stored in a vehicle communication system in a heavy vehicle or working machine. It also relates to a vehicle communication system and a heavy vehicle or working machine adapted for the same purpose.

A heavy vehicle or a working machine, such as a truck or a wheel loader, can have many different functions. A function can be the cruise control or any output in an electrical control unit (ECU) in a vehicle communication system. The ECU in turn can control a relay to start a hydraulic oil pump to a crane or similar. Each function is realized by a system containing of one or more Electrical Control Units (ECU's). The same ECU's are normally also used to realize other functions so the software has support for several different functions.

Many heavy vehicles that are delivered to customers firstly go to a bodybuilder that assembles additional functionality to the vehicle, such as a tipper body. The bodybuilder may also reassemble or remove functionalities. An electrical system of the vehicle or machine is equipped with a certain set-up of functions that are available when it is delivered to a customer or to the bodybuilder. The available functions can for example be an ECU prepared with “output drivers” that can control the functions. With this possibility, the body builder can add a body builder kit, connect the body builder kit to the correct output device and assembly an input device that controls the body builder kit.

A problem in the aftermarket is that when a function needs to be enabled or disabled, a diagnostic tool has to be used. The diagnostic tool is connected to the vehicle communication system and communicates with a master ECU in the system to enable or disable functionalities. Such tools are expensive and complicated, which limits the possibilities for the proprietor of the vehicle or machine to adapt the functionalities.

It is desirable to reduce the need of diagnostic tools for aftermarket when adding or removing functions in a heavy vehicle or working machine.

According to an aspect of the present invention, a method is provided for enabling at least one function being stored in a vehicle communication system in a heavy vehicle or working machine. The system comprises information about each function and information about a respective output signal relating to each function. The system further comprises information about a respective function identity code unique for each function. The method comprises the steps of:
a master Electronic Control Unit, ECU, in the system, receives an actuator identity code which relates to an actuator connected to the system,
the master ECU compares the received actuator identity code with the function identity codes,
the master ECU assigns a function with a function identity code that corresponds with the actuator identity code so that the actuator is enabled to control the output signal relating to the assigned function.

The main advantage with the present invention is that a diagnostic tool is no longer needed when enabling or disabling a function. Since an actuator communicates directly with the master ECU, such an instrument is redundant. Another advantage is that the vehicle or machine supplier can chose which functions that shall be delivered with the new vehicle and which function that requires a connection by computer and a new data setting.

### BRIEF DESCRIPTION OF THE DRAWINGS

The invention will he described in greater detail in the following, with reference to the embodiments that are shown in the attached drawings, in which:

FIG. 1 illustrates a possible system setup according to a first aspect of the present invention.

FIG. 2 illustrates input devices mounted on a dash board.

FIG. 3 illustrates a mapping of an input device ID in an input device to a function.

FIG. 4 illustrates the method according to the present invention.

FIG. 5 illustrates a possible system setup according to a second aspect of the present invention.

FIG. 6 illustrates a method for programming an input device according to the second aspect of the present invention.

FIG. 7 illustrates a first programming example of an input device according to the second aspect of the present invention.

FIG. 8 illustrates a list in the master ECU relating to the first programming example according to FIG. 7.

FIG. 9 illustrates an instrument cluster or similar relating to the first programming example according to FIG. 7.

FIG. 10 illustrates a second programming example of an input device according to the second aspect of the present invention.

FIG. 11 illustrates a list in the master ECU relating to the second programming example according to FIG. 10.

FIG. 12 illustrates an instrument cluster or similar relating to the second programming example according to FIG. 10.

FIG. 13 illustrates the first and second programming examples according to FIGS. 7 and 10.

FIG. 14 illustrates a wireless data link between a computer and a vehicle.

FIG. 15 illustrates graphical information on an input device for visual indication.

### DETAILED DESCRIPTION

The embodiments of the invention with further developments described in the following are to be regarded only as examples and are in no way to limit the scope of the protection provided by the patent claims.

The present invention relates to a method for enabling at least one function being stored in a vehicle communication system in a heavy vehicle or working machine. In the following the heavy vehicle or working machine will be named “vehicle”. It also relates to a vehicle communication system with an actuator and a vehicle. The actuator will in the following be named “input device” and may consist in or comprise a switch, a rotary switch, a lever or any other means for use assisted control of a function in the vehicle.

Even though the detailed description essentially describes the method performed by the system and the input device, the person skilled in the art realizes that the system and the input device, adapted to perform these method steps, are also disclosed in the description.

The present invention uses an actuator identity code for enabling the function. This code will in the following be named input device ID and will be described later. The present invention also uses a function identity code which will be described more in detail later. As will be described in the following, a comparison between input device ID and function identity code initiates an enabling of a function. The input device ID is unique for a certain input device 12.

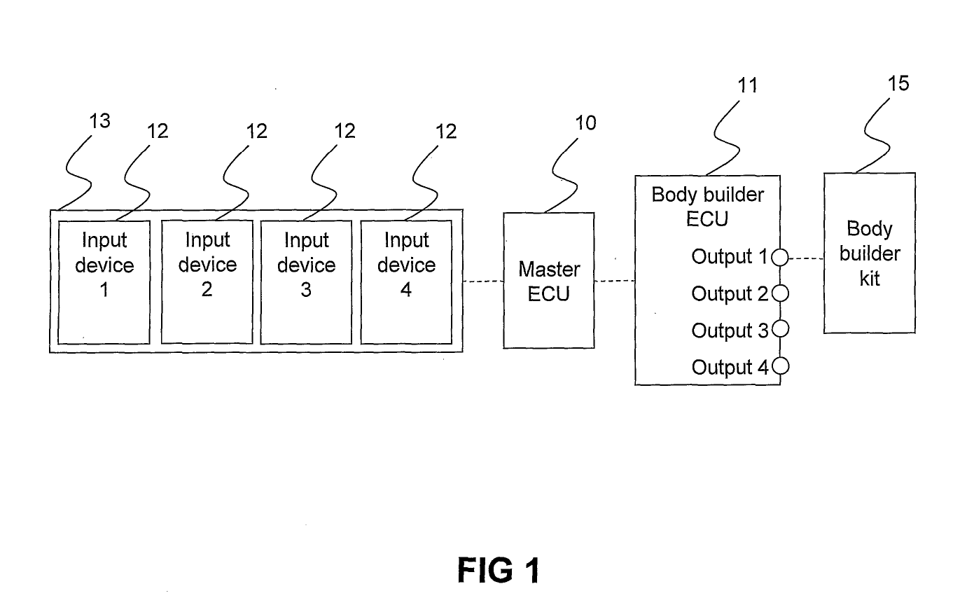

An example of a vehicle communication system in which the present invention may be implemented is shown in FIG. 1. A person skilled in the art would realize that the present invention can be implemented in vehicle communication systems of different architecture. The system comprises a master Electronic Control Unit (ECU) 10 and a body builder ECU 11 with four outputs and four input devices 12.

The vehicle communication system comprises information about functions and information about a respective output signal relating to each function. The system may store a list comprising each function, a respective function identity code (will be described later) and their respective output signal.

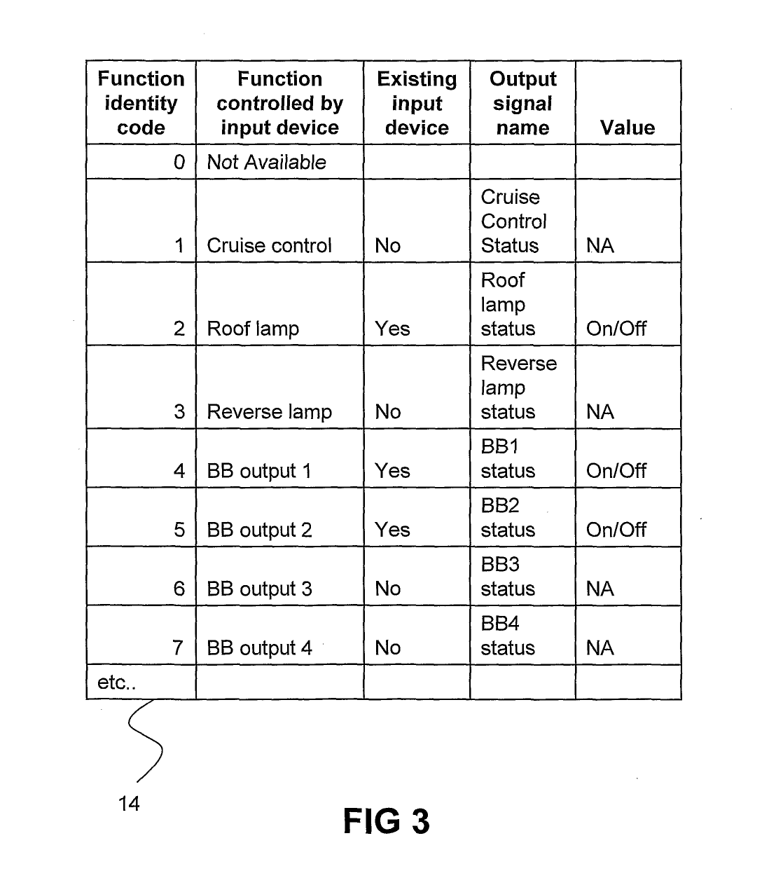

Such a list 14 with information is illustrated in FIG. 3, with name of function and output signal. Each function is realized by either one or more of the ECU's in the vehicle communication system. The same ECU'S are normally also used to realize other functions so that the software has support for several different functions. The list comprises a first set of functions, exemplified by a cruise control, a roof lamp and a reverse lamp. These functions are controlled by an output signal (named in the list).

There are also functions where the output signal is fed to an output plug, exemplified by Body Builder (BB) outputs 1-4. Such outputs may for instance be part of the Body Builder ECU, 11, see FIG. 1. Such outputs can be used to control as relay to start the hydraulic oil pump to the crane or similar. External equipments connected to the output plug for receiving the output signal are illustrated by a Body builder kit 15 in FIG. 1.

Said list 14 represents a certain set-up of functions, which the vehicle communication system is equipped with at delivery to a customer or a body builder. At least one additional function may also be downloaded from an external equipment into the system. Thereby, the vehicle can advantageously be equipped with additional functions in an easy manner. This also creates an aftermarket for additional functions.

When there is an existing input device assigned to a function, the input device controls the function. An existing input device is indicated by “Yes” in the column “Existing input device” in the list 14, while “No” means that there is no existing input device. The available status for the input device is indicated in the column “Value”. When there is no existing input device, this is indicated by “NA” in this column. This also means that when there is no existing input device, the function is disabled, and when there is an input device the function is enabled.

As illustrated in FIG. 3, the list 14 also comprises information about a respective function identity code unique for each function. As will be described in the following, this code can advantageously be used to enable a function.

To realize the system, each input device 12 comprises the input device ID. The input device itself in a first alternative communicates with the master ECU 10 via a wired or wireless communication link. There is a need that the input device comprises the complexity needed for such a communication with the system. Additional wiring harness from the input device in the cab to the function can be avoided by utilizing the already existing bus communication in the vehicle. Only the wiring harness from the output in the ECU to the function to control is needed. The benefit with the first alternative is that the input device can be installed anywhere to the system, without the feed of additional equipment.

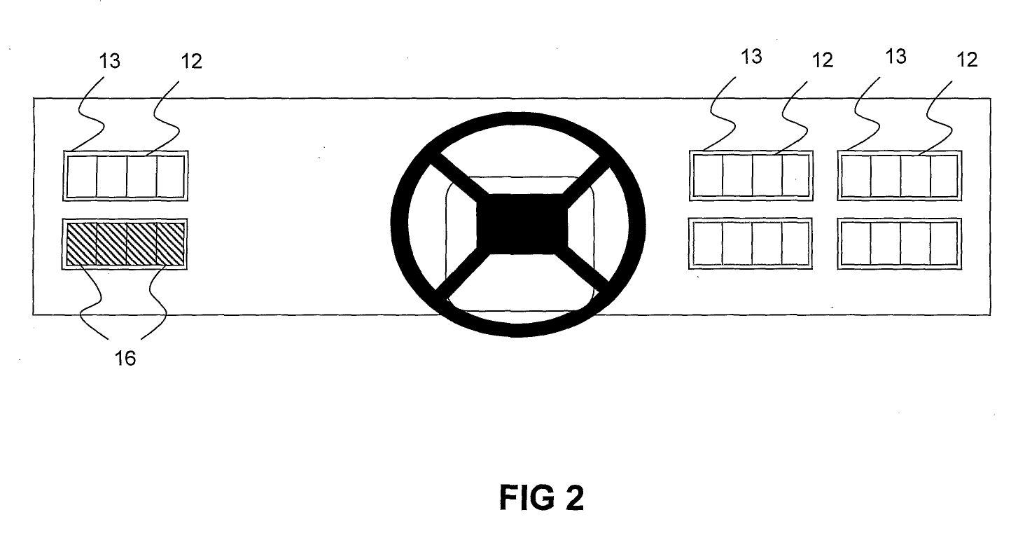

In a second alternative, the input device is installed into a panel 13. This means that when a new input device is mounted into the panel, the panel will receive the input device ID and forward the ID to the master ECU 10. FIG. 2 illustrates a panel 13 in a vehicle cab. The panel comprises a number of input devices 12 and a number of empty slots 16 where new input devices can be mounted. The panel 13 communicates with the master ECU 10. The benefit with this alternative is that the input device does not have to comprise the complexity needed for the communication with the system.

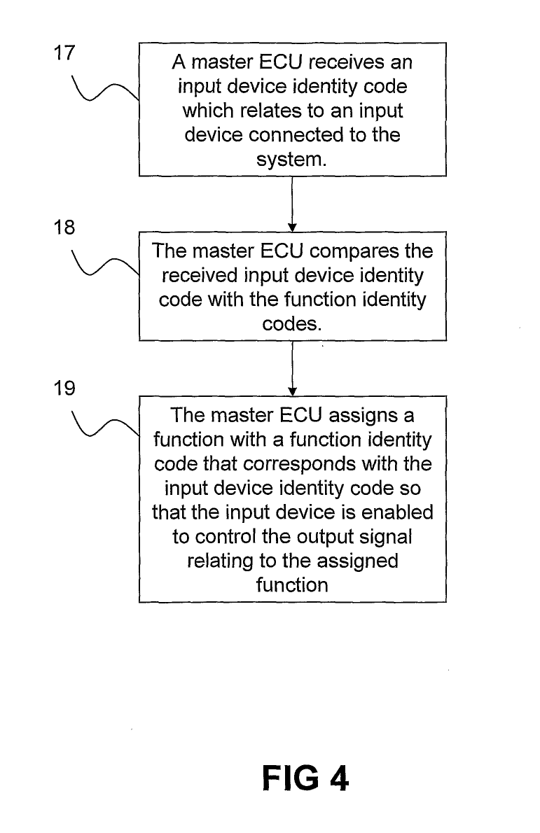

In both alternatives the master Electronic Control Unit, ECU, 10 in a first step 17 according to the present invention receives the input device ID which relates to the new input device connected to the system. See FIG. 4. The input device ID is sent either by the input device 12 or the panel 13.

In second step 18 according to the present invention, the master ECU compares the received input device ID with the function identity codes in the list 14. See FIG. 4. Each set-up function in the vehicle communication system has this unique identity code which advantageously can be used in the present invention to enable an available function by simply connecting a new input device to the control system.

In a third step 19 according to the present invention, the master ECU assigns a function with a function identity code that corresponds with the input device ID. Thereby the input device is enabled to control the output signal relating to the assigned function. See FIG. 4.

This means that to enable a function the only need is to add an input device 12 with the correct ID. If the ID corresponds to the function identity code of one of the functions in the list 14 shown in FIG. 3, the system will be configured and the function will work, otherwise not. The input device is assigned to the function by mapping the input device ID to the function.

When the function has been enabled, the information of each input device position is stored in the master. This means that, see FIG. 3, the enabled function in the list 14 will be indicated by a “Yes” in column “Existing input device” and for instance an “On/Off” in column “Value”.

When a function is enabled, the master ECU 10 may execute the function on the basis of the status of the input device 12. As an alternative, the master ECU may send information about the function together with the status of the input device to at least one second ECU. The second ECU then executes the function on the basis of said information. The output signal may also be fed to an output plug arranged for controlling an electrical load being connected to the plug.

Even though the vehicle communication system comprises several ECU's, there is no need for any other node than the master ECU to know which input devices that are available. Instead of configuring each ECU with the actual function content, the ECU's in the system knows by the signals received which functions that are enabled. Only the signals for the enabled functions are sent with a valid value. The signals for the functions that are not enabled are sent with a value=“not available” or not sent at all.

The ECU's in the system shall all be specified with the maximum possible configuration but dependent of which signal or signals that are received, different functions shall be realized. If new functions are downloaded into the system, the ECU's should be able to handle these.

In the first step 17, the master ECU 10 may receive the input device 110 together with a unique position of the input device 12 during an initialization process. The unique position refers to the position or address at which the input device is connected to the system. In such a solution, the position is mapped to the function so that the master ECU determines the status on a certain position.

When the input device ID is received during an initialization process, it is possible to reduce the data information on the communication bus since the input device ID does not need to be sent every time. Instead, dependent of the position of the input device, the status of the input device is mapped to the corresponding output signal. The master ECU may as an alternative receive the input device ID together with the status of the input device.

When the input device is received together with the status, the initialization process is not needed to enable the function. This procedure requires some extra data to be transferred on the communication bus, but the benefit is that as soon as the input device is activated the state of the input device is mapped to the function corresponding to the ID in the input device. As illustrated in FIG. 3, the list 14 comprises information about a respective function identity code unique for each function.

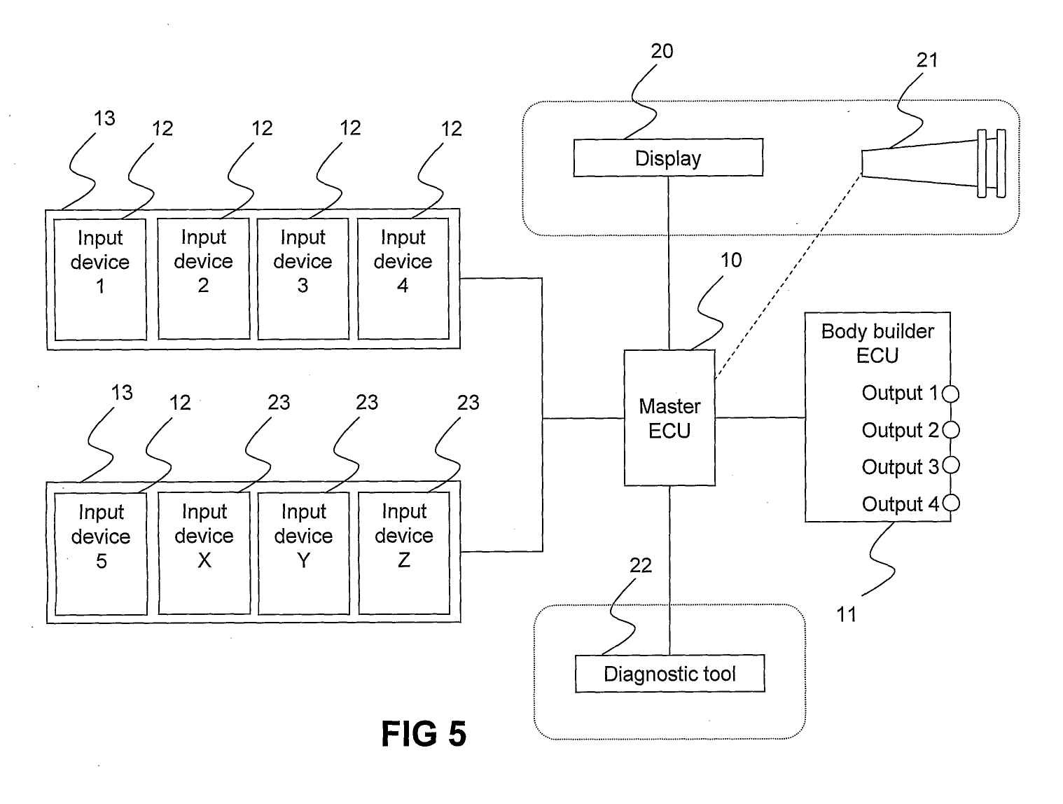

In the following a solution is disclosed for further improving the function enablement according to the present invention. With this solution, the availability on the aftermarket of input devices 12, comprising said input device ID, is improved. In order to enable said solution, there is a need that the master ECU is also connected to a display or a diagnostic tool. This is illustrated in FIG. 5. A diagnostic tool is for instance an external computer.

The system according to FIG. 5 is similar to as the system according to FIG. 1. It comprises said input devices 12 mounted into a panel 13, a master ECU 10 and a body builder ECU 11. Instead of one panel, two are shown. Moreover, a display 20 and a control device 21 are connected to the master ECU. A diagnostic tool 22 may, as an alternative, be temporarily connected to the system. The control device or the diagnostic tool can be used to select and chose functions within the list 14 of functions (see FIG. 3) and the display shows said execution if done by the control device.

In the solution, the input devices can be programmed or reprogrammed. When the input device ID is programmed or a different ID is reprogrammed into the input device, the enabling of the function as disclosed in FIG. 4 can be proceeded. In the solution, three steps are performed (see FIG. 6):
In a first step the master ECU 10 sends 24 information about at least one programmable input device 12 being connected to the system.
In a second step the master ECU 10 receives 25 a request to program or reprogram at least one of said input devices.
In a third step the master ECU programs or reprograms 26 said input device.

The input device may be new, without a valid input device ID, or it may have been used already for controlling another function in the same or in another vehicle. Thus, there is a possibility that the input device ID of the new input device already exists in the vehicle.

The programming or reprogramming of the input device 12 may be initiated in different ways. For instance, the master ECU 10 may in the first step 24 send said information as a response when receiving a request to send the information. This request may have been sent by the external diagnostic tool 22 or by execution on the display 20, using the control device 21. When receiving the request, the master ECU responds with information about the programmable input devices connected to the system.

An alternative way to initiate the programming or reprogramming is that the master ECU 10 on its own motion, in the first step 24, may send the information when it receives an indication that an input device is connected to the system. This means that when the input device is installed, the information is automatically sent to for instance the display 20 or the external tool 22.

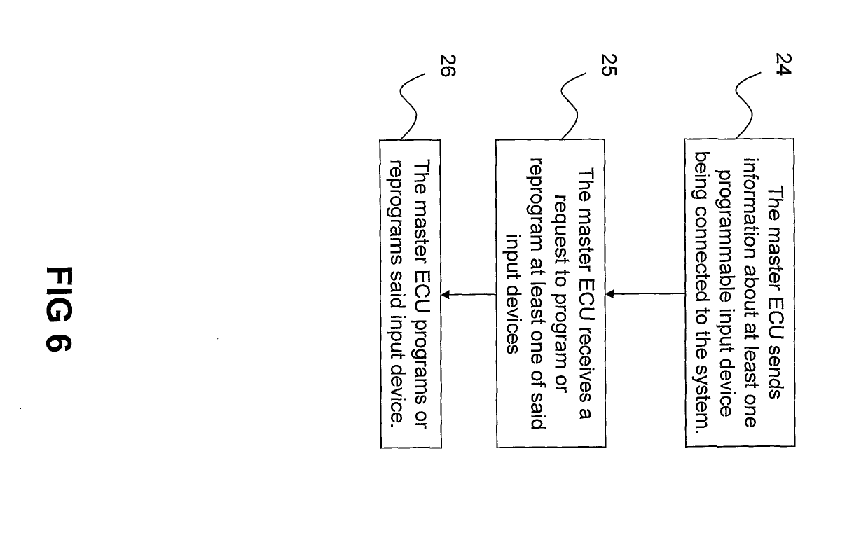

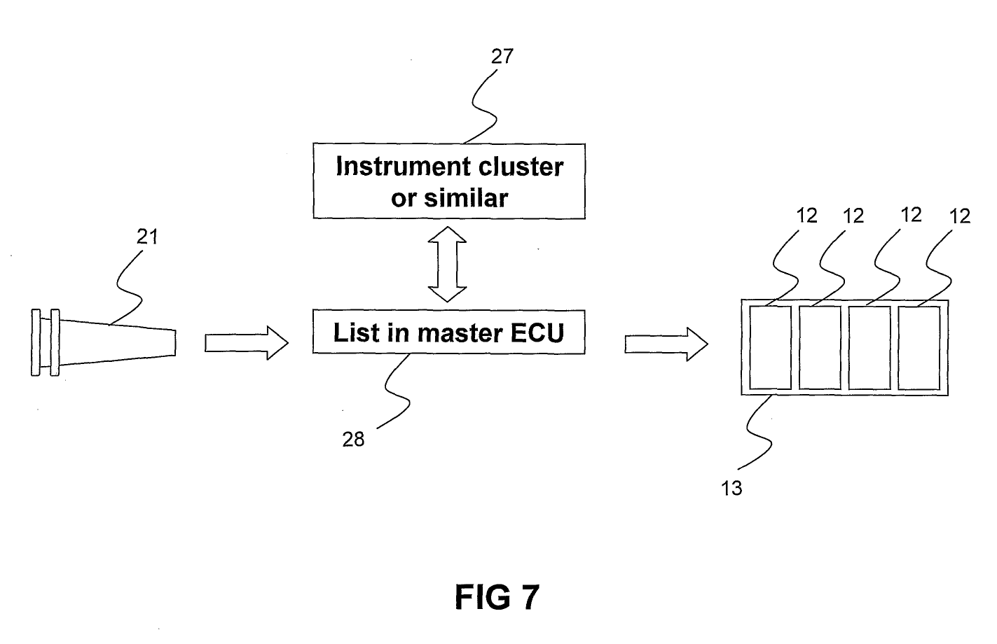

FIGS. 7-9 and 13 disclose a first example of how the input device may be programmed with input device ID. The function that the input device 12 shall control is chosen via a menu in the display 20 or via a diagnostic tool 22. In order to navigate in the menu and to determine and program the already existing input device, a stalk with a scroll wheel (control device) 21 may be used.

When an input device is assembled into the vehicle and connected 29 to the vehicle communication system, and when the master ECU 10 in the first step 24 has sent information about input devices 12 connected to the system, the user enters 30 a menu. In the menu 27 (see FIG. 9), the user can check 31 for available input devices. On the basis of the information provided 24 by the master ECU, the menu can present 32 the additional input devices detected, and as an option 33 also the type of input device detected

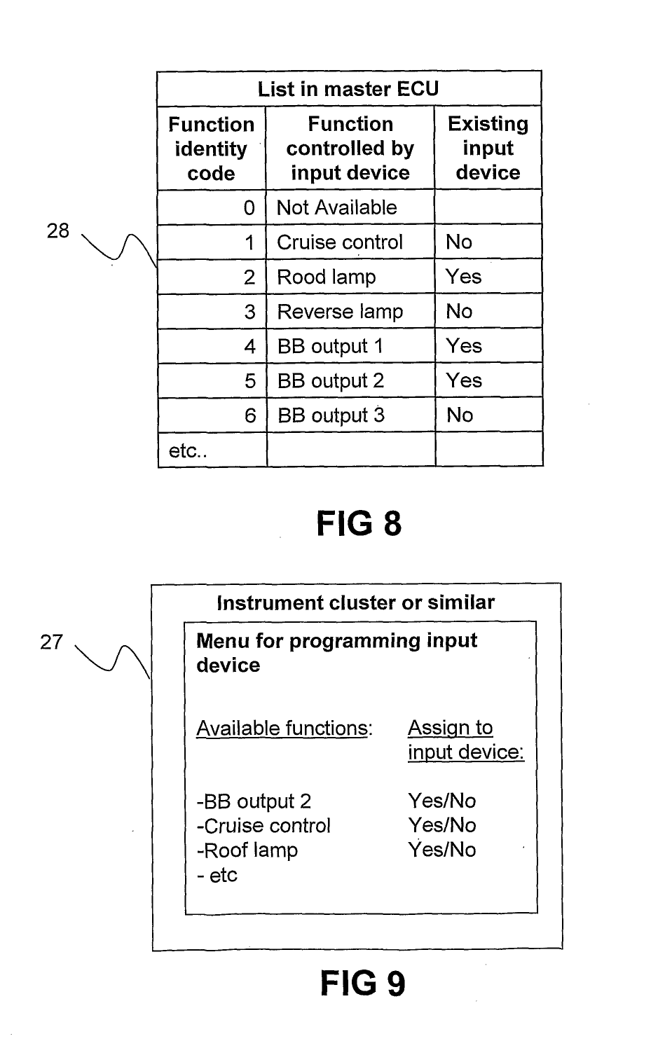

Then the user, via the menu 27, decides if a certain input device should be programmed or reprogrammed. This refers to step 34 in FIG. 12, where the user decides to assign the input device to a pre-installed function. As mentioned in relation to FIG. 3, the master ECU 10 has a list 14 of all possible functions and their corresponding input device IDs. A similar (simplified) list 28 is also shown in FIG. 8. When the user decides, the master ECU 10 receives a request, see the second step 25, to program or reprogram at least one of said input devices.

When assigning an input device with an input device ID, the ID itself is not chosen by the menu 27 but the “function”. The list 28, see FIG. 8, shall work as a database of existing functions in the vehicle that converts the function chosen by the menu to the corresponding ID to assign to the input device.

In the final step 26, see FIG. 6, the master ECU programs or reprograms the input device 12 with the input device ID relating to a certain function. This is done by sending 35 the input device ID to the input device 12 and saving the configuration.

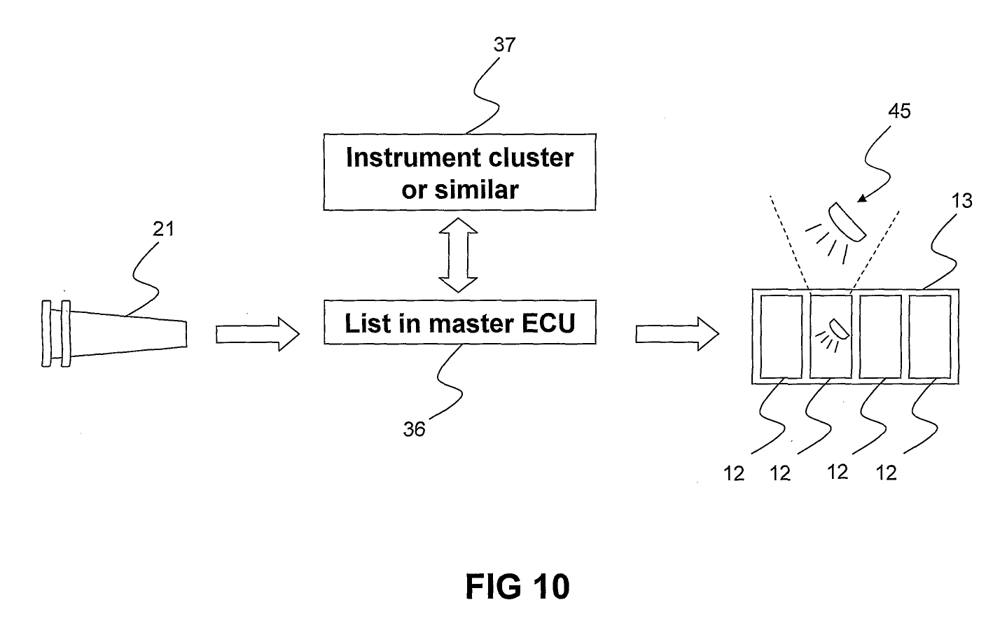

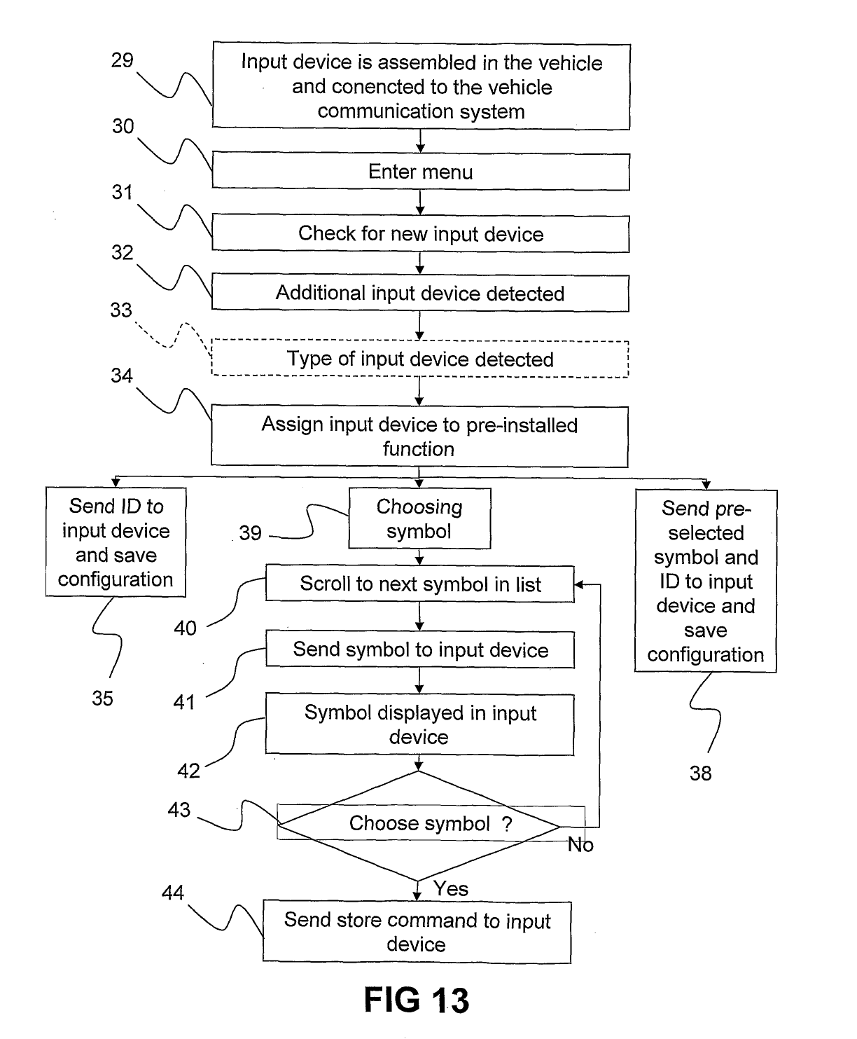

FIGS. 10-12 and 13 disclose a second example of how the input device may be programmed with input device ID. The function that the input device 12 shall control is in a similar manner chosen via a menu in the display 20 or via a diagnostic tool 22. To navigate in the menu to determine and program the already existing input device, the stalk with the scroll wheel (control device) 21 may be used. Steps 24-26 in FIG. 6 and steps 29-34 in FIG. 13 are the same as in the first example and will not be described again.

In the second example, the input device is programmed or reprogrammed with graphical information. The input device can also be programmed or reprogrammed with the input device ID in combination with said graphical information. This programming solution is used by the input device for visual indication. The vehicle communication system may comprise the graphical information. In the following, the graphical information will be referred to as a symbol 45, see FIG. 10.

Normally, the input device 12 is delivered with a neutral symbol that has a generic marking, such as “AUX”. The input device marked with “AUX” controls any output where a relay or any other device can be connected. To know which function that is controlled by the input device, the input device can be equipped with a surface which can be adopted to display a symbol. The display can be of different types, e.g. an LCD type with an illumination from behind the display, an OLED type which does not require a backlight or equal display which can be used to connect the input device to the function that shall be controlled.

The input device may be programmed or reprogrammed with the symbol as the ID to the input device is programmed. This refers to step 35 in FIG. 13. The input device itself keeps a number of symbols in a non-volatile memory and dependent of the ID the input device is programmed with, the symbol is automatically chosen.

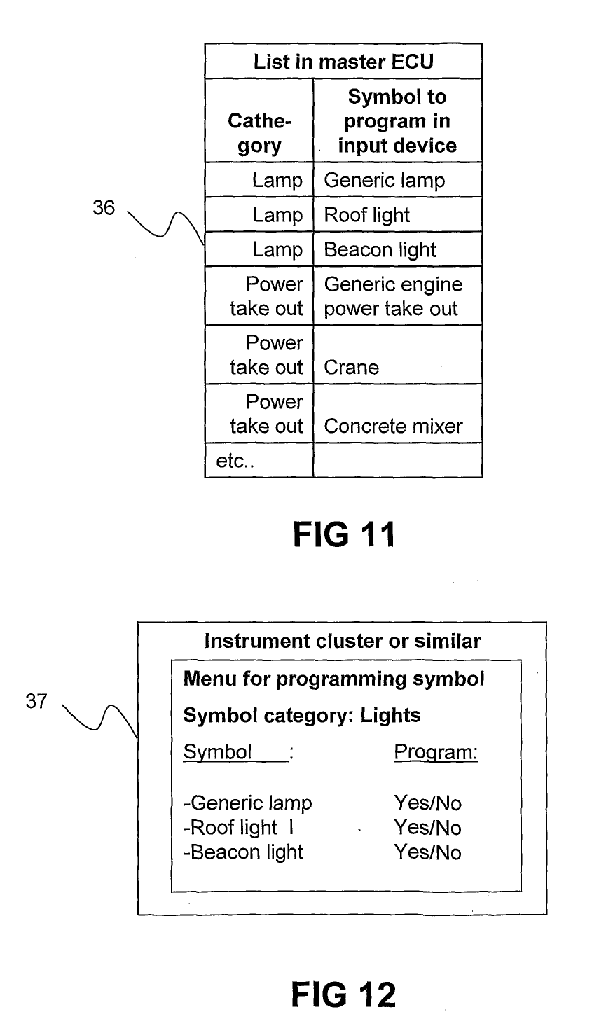

The input device may also be programmed or reprogrammed with the symbol when the ID to the input device is programmed. This means that the vehicle communication system keeps a number of symbols in a list in a non-volatile memory. FIG. 11 illustrates a list 36 with possible symbols and possible function categories. Dependent of the ID the input device 12 is programmed with, the symbol is automatically selected. When the function for the input device is chosen, the ID and the pre-selected symbol is sent 38 (see FIG. 13) to the input device and then the configuration is saved.

The input device may also be programmed or reprogrammed with the symbol independently of the input device ID programming. The function is then already chosen for the input device, but not the symbol. The symbol is downloaded to the input device independent of the function that is chosen for the input device.

The operator himself can choose the symbol he likes. The master hosts a list 36 of the different symbols and communicates each symbol to the input device as the search of the symbol list is processed. The symbol is chosen 39 by scrolling 40 through a menu until the desired symbol appears 42 in the input device. This symbol appears when the chosen symbol is sent 41 to the input device. When the desired symbol is chosen 43, the master sends 44 a “store command” to the input device 12 to save the symbol in its non-volatile memory.

With the programming of input devices the number of part numbers can be reduced. Only one part number is needed for each type of input device and not one part number for each function to control. Therefore, the probability is higher that the input device is available immediately at the dealer or workshop. The workshop can also order an input device without taking into account the function that shall be controlled. Only the type of input device that is required must be specified. The function is programmed on spot in the vehicle.

The invention is not to be regarded as being limited to the embodiments described above, a number of additional variants and modifications being possible within the scope of the subsequent patent claims.

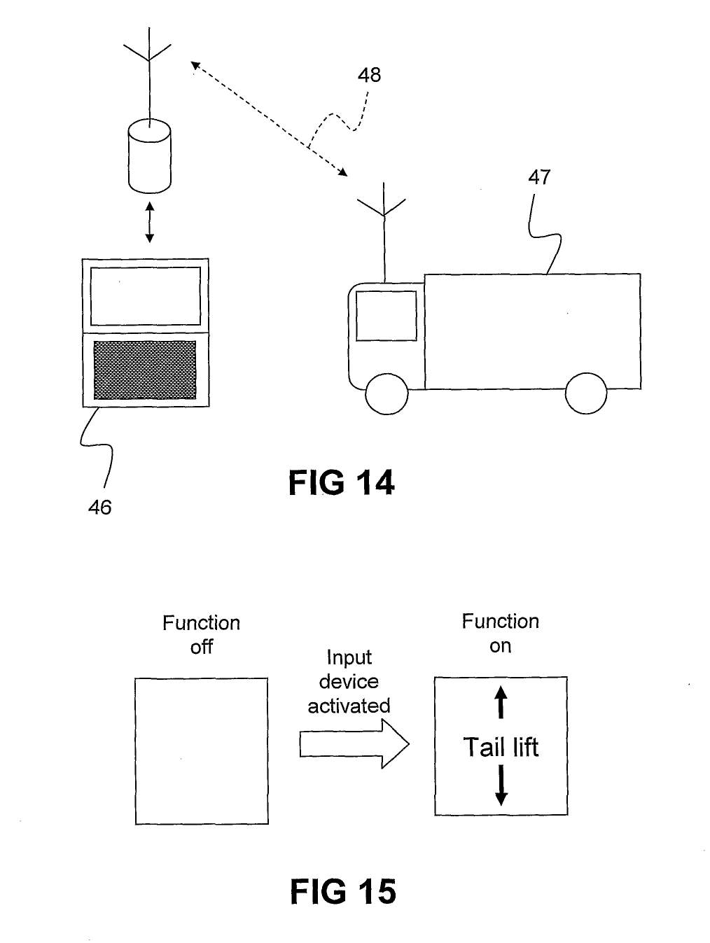

For instance, additional graphical information (symbols) may be downloaded into the system. If the desired symbol is not available in the vehicle communication system, the symbol can be created using a computer aided user interface 46 on a website or in a computer tool in the workshop. When the symbol is finalized it is being downloaded to the master ECU 10 in the vehicle 47 either via a diagnostic tool plugged in to the data link through a connector in the vehicle or through a wireless link 48 used to communicate between the vehicle and computer system. See FIG. 14.

The computer system is basically a PC communicating with a central computer system which can be accessed over the internet. The central computer can access any vehicle equipped with a wireless communication system without the need of getting the vehicle to a workshop. When the new symbol is downloaded to the master ECU it can be accessed in the vehicle and programmed.

For instance, the input device may be programmed with multiple symbols. The input device can then be adopted to display the symbol for the function that for the moment is active. See FIG. 15. When a function is “off”, the input device has one symbol and when the function is “on”, the symbol is different. One possible application when to use the same input device for different functionality can he a level control, such as the tail lift. When the function is enabled, the input device may for instance change colour, symbol and/or appearance. When a different function is enabled, the same input device can be used for that function. There can be a number of different input device colour backgrounds. The colour of the input device can be changed when a function is activated or the illumination can be turned off when the function cannot be used for example when the engine is not running.

Finally, a person skilled in the art would realize that the present invention also embraces an event where the input device 12 is removed from the system. If the device is removed, the system may for instance disable the function and change the indication in the lists 14, 28 so that there is a “No” in the column. “Existing input device” and “NA” in the column “Value”. This means that when there is no existing input device, the function is disabled, and when there is a device the function is enabled. As described, the function which is disabled may be assigned to a different input device. For instance by installing a new device with the same code or by reprogramming the input device ID in a certain, already installed device.

1. A method for enabling at least one function to be stored in a vehicle communication system in a heavy vehicle or working machine, the system comprising information about each function and information about a respective output signal relating to each function, the system further comprising information about a respective function identity code unique for each function, the method comprising:
receiving, via a master Electronic Control Unit (ECU), in the system an actuator identity code which relates to an actuator connected to the system,
comparing, via the master ECU, the received actuator identity code with the function identity codes,
assigning, via the master ECU, a function with a function identity code that corresponds with the actuator identity code so that the actuator is enabled to control the output signal relating to the assigned function.

2. A method according to claim 1, wherein the actuator is assigned to the function by mapping the actuator identity code to the function.

3. A method according to claim 1, wherein the master ECU receives the actuator identity code together with the unique position of the actuator during an initialization process.

4. A method according to claim 1, wherein the master ECU receives the actuator identity code together with the status of the actuator.

5. A method according to claim 1, wherein master ECU executes the function on the basis of the status of the actuator.

6. A method according to claim 1, wherein the master ECU sends information about the function together with the status of the actuator to at least one second ECU, the second ECU executes of the function on the basis of the information.

7. A method according to claim 1, wherein the output signal is fed to an output plug arranged for controlling an electrical load being connected to the plug.

8. A method according to claim 1, comprising:
sending, via the master ECU, information about at least one programmable actuator being connected to the system,
receiving, via the master ECU, a request to program or reprogram at least one of the actuators,
programming or reprogramming, via the master ECU, the actuator.

9. A method according to claim 8 wherein the master ECU sends the information as a response when receiving a request to send the information.

10. A method according to claim 8 wherein the master ECU sends the information when receiving an indication that an actuator is being connected to the system.

11. A method according to claim 8, wherein the master ECU programs or reprograms the actuator with the actuator identity code relating to a certain function.

12. A method according to claim 8, wherein the master ECU programs or reprograms the actuator with graphical information used by the actuator far visual indication.

13. A vehicle communication system adapted for performing the method according to claim 1.

14. A vehicle communication system according to claim 13 wherein the system comprises at least one actuator with a reprogrammable memory.

15. A vehicle communication system according to claim 14 wherein the actuator is adapted for visual indication of the function assigned to the actuator and/or the status of the actuator.

16. A heavy vehicle or working machine comprising the vehicle communication system according to claim 13.
